(19) United States
(12) Patent Application Publication
(10) Pub. No.: US 2005/0282138 A1
(43) Pub. Date: Dec. 22, 2005

(54) Computer-based data processing system and method for assessing the effectiveness of knowledge transfer

(76) Inventor: Stefan Dittli, Winterthur (CH)

Correspondence Address: MICHAEL D. BEDNAREK;SHAW PITTMAN LLP, 1650 TYSONS BOULEVARD, MCLEAN, VA, 22102, US

(21) Appl. No.: 10/871,575

(22) Filed: Jun. 21, 2004

(51) Int. Cl. G09B 7/00

(52) U.S. Cl. 434/362

(57) ABSTRACT

A computer-based data processing system is designed for assessing the level of effectiveness of knowledge transfer directed to defined areas of expertise. Sets of quality indicators are stored in a database of the data processing system. Each set of quality indicators is assigned to one of the defined areas of expertise. For an instance of knowledge transfer (i.e. a course or a consulting program), selected areas of expertise are specified from the defined areas of expertise (i.e. training or consulting modules). Rating values are received in the data processing system for the quality indicators of the sets assigned to the selected areas of expertise. The rating values are stored in the database, each of the rating values being assigned to one of the quality indicators of a set assigned to one of the selected areas of expertise. The level of effectiveness of the instance of knowledge transfer directed to the selected areas of expertise is computed from the rating values assigned to the quality indicators of the sets assigned to the selected areas of expertise. For the instance of knowledge transfer, expected time and cost savings are computed from the level of effectiveness. The time savings are weighted by a student's competence level prior to the knowledge transfer and by a student's assessment of the quality of the knowledge transfer.

### FIELD OF THE INVENTION

The present invention relates to a computer-based data processing system and a computer-based method for determining the level of effectiveness of knowledge transfer. Specifically, the present invention relates to a computer-based data processing system and a computer implemented method for assessing the level of effectiveness of knowledge transfer directed to more than one defined area of expertise.

### BACKGROUND OF THE INVENTION

For any organization education and re-education of its employees is absolutely necessary for improving and maintaining internal know-how, skills, and work efficiency. Typically, knowledge related to specific areas of expertise, for example handling of electronic information, is transferred from an expert to one or more students. The expert may be a teacher, transferring knowledge in a classical course setting according to a teaching program, or a consultant or coach, transferring knowledge to a client according to a consulting program. Knowledge may also be transferred as part of a knowledge transfer initiative including teaching and/or consulting programs. In order to evaluate the quality of a teacher, a consultant, or a teaching or consulting program, the quality of the knowledge transfer is determined based on feedback from the students or clients. Conventionally, quantified feedback from the students or clients is entered in a spreadsheet program or a statistical software package configured specifically for the particular consulting program, teaching program, or course. In the spreadsheet program or statistical software package the quality of the knowledge transfer is determined by computing averages of the quantified feedback recorded from the students or clients. Consulting programs, teaching programs, or courses often relate to more than one area of expertise and include multiple consulting or training modules, each addressing a different area of expertise. For example, a consulting program related to general management may include consulting modules addressing budget control, leadership skills, and project management; a course about project management may include training modules addressing project planning and scheduling, project monitoring and controlling, and project reporting. Depending on the learning goal, the client, and/or the group of students, different modules addressing different areas of expertise are combined to form the basis of a course, teaching program, or consulting program. The areas of expertise included and covered in a course, teaching program, or consulting program may also vary over time. Furthermore, depending on the areas of expertise included in a course, teaching program, or consulting program, different aspects and criteria are used to determine the effectiveness of the knowledge transfer. Consequently, depending on the areas of expertise included in a course, teaching program, or consulting program, different configurations of spreadsheet programs or statistical software packages are required for determining the quality of the knowledge transfer. Particularly in organizations with a great variety and number of teaching programs and/or consulting programs, the constant changes and adaptations of configurations of spreadsheets and software packages are considered inefficient and prone to errors.

### SUMMARY OF THE INVENTION

It is an object of this invention to provide a computer-based data processing system and a computer implemented method for assessing the level of effectiveness of knowledge transfer directed to more than one defined area of expertise, which system and method do not have the disadvantages of the prior art. In particular, it is an object of the present invention to provide a computer-based data processing system and a computer-based method for assessing the level of effectiveness of knowledge transfer directed to a varying set of defined areas of expertise. It is a further object of the present invention to provide a computer-based data processing system and a computer-based method for assessing the level of effectiveness of knowledge transfer directed to defined areas of expertise requiring different types of quality indicators.

According to the present invention, the above-mentioned objects are particularly achieved in that, for assessing the level of effectiveness of knowledge transfer directed to more than one defined area of expertise, different sets of quality indicators are stored in the data processing system, wherein each set of quality indicators is assigned to one of the defined areas of expertise. Moreover, the data processing system is provided with a configuration module for specifying for an instance of knowledge transfer selected areas of expertise from the defined areas of expertise. For example, for defining an instance of knowledge transfer related to information management, “management of electronic information”, “management of physical information”, and “planning and coordinating based on electronic and physical information” are specified as selected areas of expertise. Furthermore, the data processing system is provided with a rating module for receiving and storing rating values. Each of the rating values is assigned to one of the quality indicators of a set assigned to one of the selected areas of expertise. In addition, the data processing system is provided with a scoring module for computing the level of effectiveness of the knowledge transfer directed to the selected areas of expertise. The level of effectiveness is computed from the rating values assigned to the quality indicators of the sets assigned to the selected areas of expertise. For measuring the effectiveness of knowledge transfer, the proposed system and method make it possible to specify flexibly selected areas of expertise to be included and to determine automatically the corresponding quality indicators to be used. Furthermore, the proposed system and method make it possible to control a user interface such that a user is prompted to enter exactly and exclusively the rating values for those quality indicators used for measuring the effectiveness of knowledge transfer for the selected areas of expertise. Thus, the proposed system and method provide a flexible framework for measuring the effectiveness of knowledge transfer in environments where teaching or consulting programs are directed to varying areas of expertise requiring different types of quality indicators. The computed level of effectiveness of knowledge transfer can be used effectively to identify efficient and inefficient courses, training or consulting modules, consultants and/or teachers.

In a preferred embodiment, the data processing system comprises means for receiving and storing amounts of estimated maximum time savings, wherein each amount of estimated maximum time savings is assigned to one of the defined areas of expertise. Moreover, the scoring module is designed to compute from the level of effectiveness and from the amounts of estimated maximum time savings an amount of expected time savings for the selected areas of expertise. The computed amount of expected time savings can be used effectively to forecast time savings expected from a course, teaching program, consulting program, consulting module, or training module based on qualitative feedback from students and clients (rating values) and estimated maximum time savings provided by experts.

It must be emphasized that, in the context of this document, the term “student” relates not only to students or trainees participating in knowledge transfer in a classical student-teacher course setting, but also to clients participating in knowledge transfer provided by one or more consultants as part of a consultant program or knowledge transfer initiative, particularly, a program or an initiative related to knowledge and information management. Correspondingly, the term “knowledge transfer” not only relates to the transfer of knowledge in a classical course or class setting but also to the transfer of knowledge through consulting, consulting programs, or general initiatives for improvement of know-how and skills. Consequently, the term “teacher” also includes consultants, trainers, coaches, and defined teams thereof.

In a preferred embodiment, the rating module is designed to receive and store student specific rating values and the scoring module is designed to compute student specific amounts of expected time savings. In a further embodiment, the data processing system is provided with means for receiving and storing amounts of student specific, subjective time savings, and the scoring module is designed to compute student specific amounts of time savings from the student specific amounts of expected time savings and from the student specific amounts of subjective time savings. Including in the computation subjective time savings indicating the students' time savings experienced after the knowledge transfer makes it possible to consider not only an expert's opinion of estimated maximum time savings but also quantitative feedback from the students.

In an embodiment, the scoring module is designed to compute the level of effectiveness of the knowledge transfer from student specific rating values of a plurality of students and the scoring module is designed to exclude student specific rating values from students having a student specific amount of expected time savings deviating by more than a defined value from the student specific amount of subjective time savings Excluding a student specific rating value based on a significant deviation of the student specific amount of expected time savings from the student specific amount of subjective time savings makes it possible to exclude automatically statistical outliers from the assessment of effectiveness,

In a preferred embodiment, the data processing system further includes means for receiving and storing student specific competence levels indicating a student's level of competence prior to the knowledge transfer. Furthermore, the scoring module is designed to compute student specific amounts of expected time savings, the student specific amounts of expected time savings being weighted depending on a student's specific competence level. Weighting student specific amounts of expected time savings depending on a student's competence level prior to the knowledge transfer makes it possible to consider automatically the relative impact of a student's prior knowledge onto the amount of expected time savings. Typically, a student with great prior knowledge has smaller potential time savings than a student with only basic or no prior knowledge in the respective areas of expertise.

In a preferred embodiment, the data processing system further includes means for receiving and storing student specific consulting quality levels indicating a student's assessment of the quality of the knowledge transfer. Furthermore, the scoring module is designed to compute student specific amounts of expected time savings, the student specific amounts of expected time savings being weighted depending on a student's specific consulting quality level. Weighting student specific amounts of expected time savings depending on a student's assessment of the quality of the knowledge transfer makes it possible to consider automatically the relative impact of a student's subjective experience of the knowledge transfer onto the amount of expected time savings. Typically, a student giving a very positive assessment of the quality of the knowledge transfer has greater potential time savings than a student giving an average assessment, whereas a student giving a very negative assessment of the quality of the knowledge transfer has smaller potential time savings than the student giving the average assessment.

In a preferred embodiment, the data processing system further includes means for receiving and storing amounts of estimated maximum time savings, wherein each amount of estimated maximum time savings is assigned to one of the defined areas of expertise, means for receiving and storing amounts of student specific, subjective time savings, means for receiving and storing student specific competence levels indicating a student's level of competence prior to the knowledge transfer, and means for receiving and storing student specific consulting quality levels indicating a student's assessment of quality of the knowledge transfer The rating module is designed to receive and store student specific rating values and the scoring module is designed to compute an amount of expected time savings for the selected areas of expertise, wherein the amount of expected time savings is computed from student specific amounts of expected time savings, wherein the student specific amounts of expected time savings are computed from the amounts of estimated maximum time savings, from the student specific rating values, and from the amounts of student specific, subjective time savings, and wherein the student specific amounts of expected time savings are weighted dependent on a student's specific competence level and on a student's specific consulting quality level.

Preferably, the data processing system further includes means for assigning weighting factors to the quality indicators and the scoring module is designed to compute the level of effectiveness according to the weighting factors. In this way, different significance of quality indicators can be reflected in the assessment of effectiveness.

Preferably, the data processing system further includes means for assigning weighting factors to the selected areas of expertise and the scoring module is designed to compute the level of effectiveness according to the weighting factors. In this way, different significance of areas of expertise can be reflected in the assessment of effectiveness.

In addition to a computer-based method for assessing the level of effectiveness of knowledge transfer directed to defined areas of expertise, the present invention also relates to a computer program product including computer program code means for controlling one or more processors of a computer, particularly, a computer program product including a computer readable medium containing therein the computer program code means.

### BRIEF DESCRIPTION OF THE DRAWINGS

The present invention will be explained in more detail, by way of example, with reference to the drawings in which:

FIG. 1 shows a block diagram illustrating schematically an exemplary configuration of a computer-based data processing system for practicing embodiments of the present invention, said configuration comprising a computer with a processor and memory, and said configuration being connected to peripheral data entry terminals.

FIG. 2 shows a flow diagram illustrating an example of a sequence of preparatory steps executed according to the present invention.

FIG. 3 shows a flow diagram illustrating an example of a sequence of configuration steps executed according to the present invention.

FIG. 4 shows a flow diagram illustrating an example of a sequence of steps executed according to the present invention for assessing a level of effectiveness of knowledge transfer directed to defined areas of expertise.

### DETAILED DESCRIPTION OF THE PREFERRED EMBODIMENTS

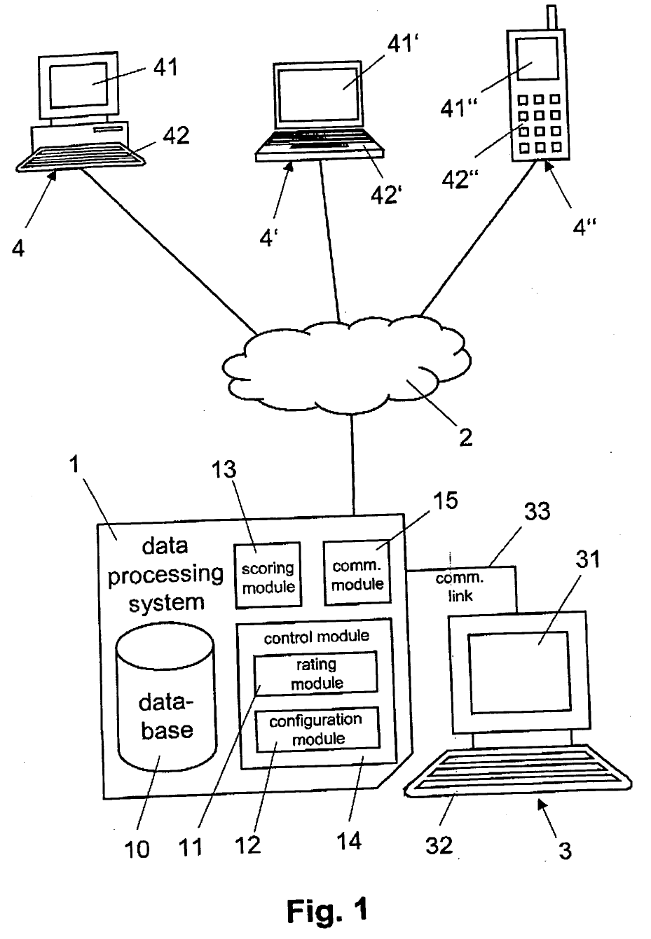

In FIG. 1, reference numeral 1 refers to a computer-based data processing system. The data processing system 1 includes one or more computers, for example personal computers, comprising one or more processors. As is illustrated schematically, the data processing system 1 is connected to different peripheral data entry terminals. The reference numeral 3 refers to a local data entry terminal connected directly to the data processing system 1 via communication link 33. The reference numerals 4, 4′, 4″ refer to remote data entry terminals in the form of a personal computer, a laptop computer, and a mobile radio telephone or personal digital assistant, respectively. The remote data entry terminals 4, 4′, 4″ are connected to the data processing system 1 via telecommunication network 2. The reference numeral 15 refers to a communication module. The communication module 15 is designed for data communication with the remote data entry terminals 4, 4′, and 4″ via the telecommunication network 2 and with the local data entry terminal 3 via the communication link 33.

The telecommunication network 2 includes fixed networks and wireless networks. For example, the telecommunication network 2 includes a local area network (LAN), an integrated services digital network (ISDN), the Internet, a global system for mobile communication (GSM), a universal mobile telephone system (UMTS) or another mobile radio telephone system, and/or a wireless local area network (WLAN).

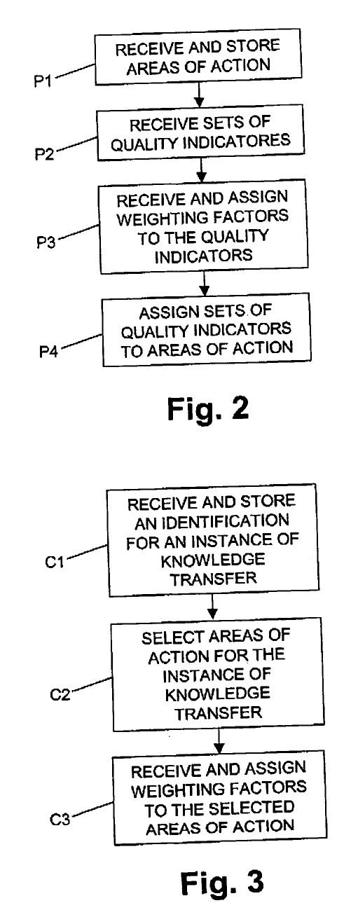

As is illustrated schematically in FIG. 1, the data processing system 1 further includes a database 10 and various functional modules namely a rating module 11, a configuration module 12, a scoring module 13, and a control module 14. Preferably, the functional modules and the database 10 are implemented as programmed software modules. The computer program code of the software modules is stored in a computer program product, i.e. in a computer readable medium, either in memory integrated in a computer of the data processing system 1 or on a data carrier that can be inserted into a computer of the data processing system 1. The communication module 15 and the software modules can be installed on one common or on separate computers of the data processing system 1. The computer program code of the software modules controls the computer(s) of the data processing system 1 so that the data processing system executes various functions described later in more detail with reference to FIGS. 2, 3, and 4.

The control module 14 is designed to control the user interfaces of the local data entry terminal 3 and the remote data entry terminals 4, 4′, 4″. The user interfaces of the local data entry terminal 3 and the remote data entry terminals 4, 4′, 4″ are visualized on the displays 31, 41, 41′, 41″ and include graphical user interfaces, forms, and/or web pages in the form of HTML (Hypertext Markup Language) or XHTML (Extended Hypertext Markup Language), for example. As is illustrated in FIG. 1, the configuration module 12 and the rating module 11, explained later in more detail, are included in the control module 14. The configuration module 12 is concerned with the definition, setup, and configuration of instances of knowledge transfer (i.e. course, teaching program, or consulting program), including areas of expertise (i.e. training or consulting modules) and associated quality indicators. The rating module 11 is concerned with the recording of rating values for the quality indicators associated with the areas of expertise of an instance of knowledge transfer.

FIG. 2 shows a flow diagram illustrating preparatory steps for entering and storing different areas of expertise and associated quality indicators in the database 10. The preparatory steps P1 to P4 can be executed by a user of a data entry terminal 3, 4, 4′, 4″ at any time when new areas of expertise and/or quality indicators need to be added to the data processing system 1. Preferably, the user can request execution of the preparatory steps P1 to P4 through a menu of the user interface provided by control module 14.

In step P1, the configuration module 12 prompts a user of a data entry terminal 3, 4, 4′, 4″ to define and enter areas of expertise. For example, the areas of expertise are defined by one or more key words, for example “electronic information handling”, “management and consulting general”, “knowledge landscape screening”, “workshop (topic)”, “information audit”, “process support (communication/documentation)”, “communication consulting”, “virtual collaboration consulting”, “information process design”, “knowledge workplace consulting”, “customized information competence”, “content integration”, “project management”, or “risk management”. The areas of expertise defined and entered by the user are received by the configuration module 12 and stored in database 10.

In step P2, the configuration module 12 prompts the user to define and enter sets of quality indicators. For example, the set is defined by an alphanumeric code or a keyword such as “A”. The quality indicators are defined, for example, by an alphanumeric code or a keyword such as “A1”, “A2”, “A3”, and a worded question such as “how has the efficiency of using electronic mail improved?”. Once the user has indicated that the set of quality indicators is complete, the set of quality indicators defined and entered by the user is stored by the configuration module 12 in database 10.

In step P3, the configuration module 12 prompts the user to enter and assign weighting factors to the quality indicators of the set defined in step P2. For example, in a set of three quality indicators, weighting factors of 50%, 20%, and 30% are assigned to the first, second, or third quality indicator, respectively. The weighting factors entered and assigned to the quality indicators are received by the configuration module 12 and stored in database 10.

In step P4, the configuration module 12 prompts the user to assign the sets of quality indicators defined in step P2 and weighted in step P3 to one of the areas of expertise defined and entered in step P1. For example, the user can perform the assignment by selecting one area of expertise from a drop down list containing the areas of expertise defined in step P1 and by selecting one set of quality indicators from a drop down list containing the sets of quality indicators defined in step P2. Data related to the assignment specified by the user is received by the configuration module 12 and reflected in database 10 by linking the set of quality indicators and the area of expertise previously selected.

The expert will understand, that it is also possible to arrange the preparatory steps P1 to P4 in a different sequence, for example, P4 could be executed before step P3, or the area of expertise to which a set of quality indicators is to be assigned could be specified before execution of P2.

TABLE 1

| | Set of | | Weight- |
|---|---|---|---|
| Area of expertise | quality | Quality | ing |
| (training or consulting module) | indicators | indicator | factor |
| Management of electronic information | “A” | “A1” | 50% |
| Management of electronic information | “A” | “A2” | 20% |
| Management of electronic information | “A” | “A3” | 30% |
| Management of physical information | “B” | “B1” | 60% |
| Management of physical information | “B” | “B2” | 40% |
| Planning and coordinating using | “C” | “C1” | 50% |
| electronic and physical information | | | |
| Planning and coordinating using | “C” | “C2” | 50% |
| electronic and physical information | | | |

As is illustrated in Table 1, the defined areas of expertise are linked to sets of quality indicators. The expert will understand that the sets of quality indicators can be stored in the same table as the areas of expertise or in another table.

FIG. 3 shows a flow diagram illustrating configuration steps for defining and storing an instance of knowledge transfer (i.e. a particular course, teaching program, or consultant program) in database 10. The configuration steps C1 to C3 can be executed by a user of a data entry terminal 3, 4, 4′, 4″ at any time when a new instance of knowledge transfer needs to be defined in the data processing system 1. Preferably, the user can request execution of the configuration steps C1 to C3 through a menu of the user interface provided by the control module 14.

In step C1, the configuration module 12 prompts the user of the data entry terminal 3, 4, 4′, 4″ to define and enter an identifier for an instance of knowledge transfer. For example, an identifier for an instance of knowledge transfer is defined by one or more key words, for example “knowledge and information management”. The identifier for an instance of knowledge transfer defined and entered by the user is received by the configuration module 12 and stored in database 10.

In step C2, the configuration module 12 prompts the user to select areas of expertise to be included in the instance of knowledge transfer defined in step C1. For example, the user can select the areas of expertise from a drop down list or through checks in a list containing the areas of expertise defined in step P1. Data related to the linking of the selected areas of expertise to the instance of knowledge transfer defined in C1 is received by the configuration module 12 and reflected in the database 10 by linking the selected areas of expertise to the instance of knowledge transfer defined previously.

In step C3, the configuration module 12 prompts the user to enter and assign weighting factors to the areas of expertise selected in step C2. For example, in an instance of knowledge transfer with three areas of expertise, weighting factors of 50%, 25%, and 25% are assigned to the first, second, or third area of expertise, respectively. The weighting factors entered and assigned to the areas of expertise are received by the configuration module 12 and stored in the database 10.

As is illustrated in Table 2, the selected areas of expertise and their weighting factors are linked to an instance of knowledge transfer. The expert will understand that the sets of quality indicators can be stored in the same table as the areas of expertise or in another table.

TABLE 2
Instance of knowledge transfer

| | | | Estimated maximum | |
|---|---|---|---|---|
| | | | time savings | |
| | Weighting | | | Weighting |
| | factor | Set of | | factor |
| Selected areas | (area of | quality | Quality | (quality |
| of expertise | expertise) | indicators | indicator | indicator) |
| Management of | 50% | “A” | “A1” | 50% |
| electronic | | | | |
| information | | | | |
| Management of | 50% | “A” | “A2” | 20% |
| electronic | | | | |
| information | | | | |
| Management of | 50% | “A” | “A3” | 30% |
| electronic | | | | |
| information | | | | |
| Management of | 25% | “B” | “B1” | 60% |
| physical | | | | |
| information | | | | |
| Management of | 25% | “B” | “B2” | 40% |
| physical | | | | |
| information | | | | |
| Planning and | 25% | “C” | “C1” | 50% |
| coordinating using | | | | |
| electronic and | | | | |
| physical | | | | |
| information | | | | |
| Planning and | 25% | “C” | “C2” | 50% |
| coordinating using | | | | |
| electronic and | | | | |
| physical | | | | |
| information | | | | |

As is also illustrated in Table 2, an amount of estimated maximum time savings is assigned to the instance of knowledge transfer. The amount of estimated maximum time savings represents an expert opinion of the maximum time savings that can be expected in the selected areas of expertise after “delivery” of the instance of knowledge transfer. The amount of estimated maximum time savings can be entered as part of step C1 or at a later time. In the present context, any amount of time savings can be entered or computed as daily, weekly, monthly, and/or yearly time savings.

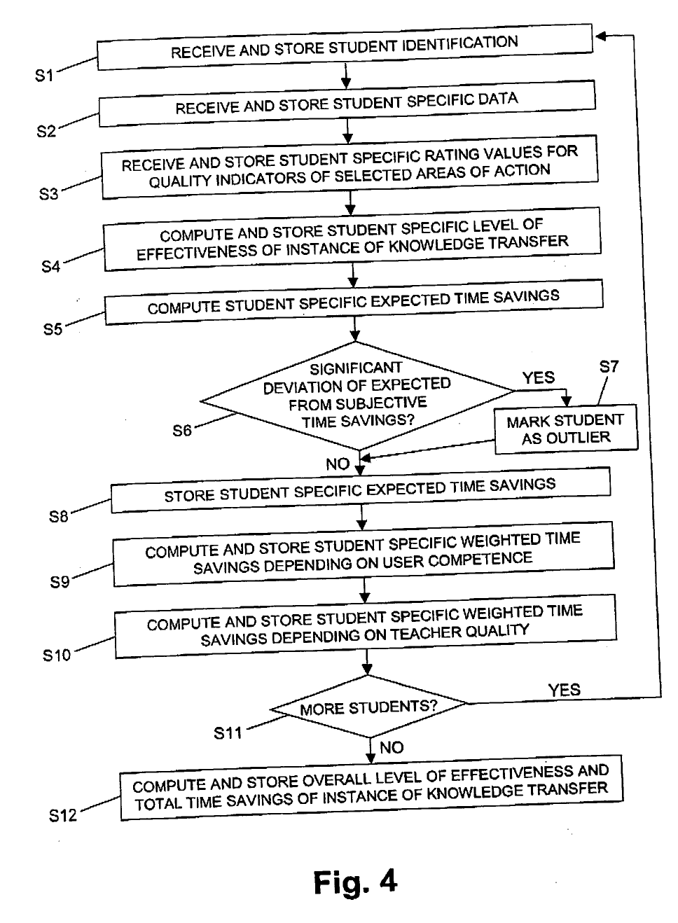

FIG. 4 shows a flow diagram illustrating an example of a sequence of steps executed for assessing the level of effectiveness of an instance of knowledge transfer directed to selected areas of expertise.

In step S1, the control module 14 prompts the user of the data entry terminal 3, 4, 4′, 4″ to enter an identification of a student (or client) participating in the instance of knowledge transfer defined in steps C1 to C3. Alternatively, before prompting the user to enter student (or client) identifications, the control module 14 may prompt the user to select another defined instance of knowledge transfer for which the level of effectiveness should be assessed instead. An identification of a student is defined, for example, by a code, a number or a name. The identification of the student can be selected from a list of students, for example. The identification of the student entered by the user is received by the control module 14 and stored in database 10. The identification of the student is assigned to the instance of knowledge transfer specified previously, i.e. the instance of knowledge transfer defined in steps C1 to C3 or selected in step S1.

In step S2, the control module 14 prompts the user to enter further student specific data such as a competence level indicating the student's level of competence prior to the knowledge transfer, a consulting quality level indicating the student's assessment of the quality of the instance of knowledge transfer, and an amount of subjective time savings indicating an amount of time savings experienced subjectively by the student after a significant period of time, e.g. three months after the course. The student specific data entered by the user is received by the control module 14 and stored in database 10. The student specific data is assigned to the student identification stored in step S1 and to the instance of knowledge transfer specified previously.

In step S3, the rating module 11 prompts the user to enter rating values for each of the quality indicators included in the sets of quality indicators assigned to the areas of expertise associated with the instance of knowledge transfer. Preferably, the rating values are selected from a drop down list or checked in a list containing the available range of rating values. For example, a range of four different rating values includes the values [0%, 33%, 66%, 100%], each rating value corresponding to a verbal description such as [no improvement, hardly any improvement, some improvement, great improvement]. The student specific rating values entered by the user are received by the rating module 11 and stored in database 10. The student specific rating values are assigned to the student identification stored in step S1 and to the instance of knowledge transfer specified previously.

In step S4, the scoring module 13 computes a student specific level of effectiveness for the instance of knowledge transfer specified previously. As is indicated in formula (1), the level of effectiveness Eff is computed from the rating values Rᵢⱼ entered and stored in step S3, from the weighting factors wᵢⱼ assigned to the respective quality indicators Iᵢⱼ, and from the weighting factors Wᵢ assigned to the areas of expertise Aᵢ included in the instance of knowledge transfer specified previously.

$$Eff = {\sum }_{i} {W}_{1} * {\sum }_{j} {R}_{ij} {w}_{ij} \qquad ( 1 )$$

The student specific level of effectiveness of the instance of knowledge transfer computed by the scoring module is stored in database 10. The student specific level of effectiveness is assigned to the student identification stored in step S1 and to the instance of knowledge transfer specified previously.

In step S5, the scoring module 13 computes a student specific amount of expected time savings. As is indicated in formula (2), the student specific amount of expected time savings Tₑₓₚ is computed from the level of effectiveness Eff computed in step S4 and the amount of estimated maximum time savings Tₘₐₓ assigned to the instance of knowledge transfer specified previously.
Tₑₓₚ=Eff*Tₘₐₓ (2)

In the optional step S6, the scoring module 13 checks whether there is a significant deviation of the student specific amount of expected time savings Tₑₓₚ computed in step S5 from the student specific amount of subjective time savings T_{sub} stored in step S2. A significant deviation is preferably defined based on the difference between the expected time savings Tₑₓₚ and the subjective time savings T_{sub}. For example, the deviation is defined as the percentage of the difference from the expected time savings Tₑₓₚ, from the subjective time savings T_{sub}, or from an average of the expected time savings Tₑₓₚ and the subjective time savings T_{sub}. If there is a significant deviation, in step S7, the student is marked as a statistical outlier; otherwise, processing continues in step S8.

In step S8, the amount of expected time savings Tₑₓₚ computed in step S5 is stored by the scoring module 13 in database 10. The amount of expected time savings Tₑₓₚ is assigned to the student identification stored in step S1 and to the instance of knowledge transfer specified previously.

In step S9, the scoring module 13 computes a student specific weighted amount of time savings T_{w1} from the student specific amount of expected time savings Tₑₓₚ computed in step S5, from the student specific amount of subjective time savings T_{sub} stored in step S2, and from the student's competence level C stored in step S2. The student specific weighted amount of time savings T_{w1} is computed as indicated in formula (3), wherein the competence level C is in the range C=[0 (no experience) . . . 20 (very experienced)). Consequently, if the student is very experienced, the weight of the computed amount of expected time savings Tₑₓₚ is reduced to 80% in formula (3). However, if the student has no experience and therefore a great potential for improvement, the weight of the computed amount of expected time savings Tₑₓₚ is not reduced in formula (3). The weighted amount of time savings T_{w1} is stored by the scoring module 13 in database 10. The weighted amount of time savings T_{w1} is assigned to the student identification stored in step S1 and to the instance of knowledge transfer specified previously.

$${T}_{w1} = \frac{{T}_{exp} * ( \frac{100 - C}{100} ) + {T}_{sub}}{2} \qquad ( 3 )$$

In step S10, the scoring module 13 computes a student specific weighted amount of time savings T_{w2} from the student specific weighted amount of time savings T_{w1} computed in step S9 and from the student specific consulting quality level Q stored in step S2. The student specific weighted amount of time savings T_{w2} is computed as indicated in formula (4), wherein the quality level Q is in the range Q=[0 (very low quality) . . . 100 (maximum quality)]. For example, if a student rates the quality of the knowledge transfer as medium (e.g. 50%), the expected time savings are reduced (e.g. to 65%); if a student rates the quality of the knowledge transfer as very good (e.g. 95%), the expected time savings are increased (e.g. to 110%). The weighted amount of time savings T_{w2} is stored by the scoring module 13 in database 10. The weighted amount of time savings T_{w2} is assigned to the student identification stored in step S1 and to the instance of knowledge transfer specified previously.

$${T}_{w2} = \frac{Q + 15}{100} * {T}_{w1} \qquad ( 4 )$$

In step S11, the control module 14 determines whether data of further students is to be recorded or whether the overall level of effectiveness and the total time savings of the instance of knowledge transfer specified previously is to be computed.

In step S12, the scoring module 13 computes the overall level of effectiveness and the total amount of time savings of the instance of knowledge transfer specified previously. Based on formula (1), the overall level of effectiveness is computed from all the student specific rating values recorded in step S3 for the instance of knowledge transfer. For example, the overall level of effectiveness is computed as an average from all the student specific levels of effectiveness stored in step S4 for the instance of knowledge transfer. In an embodiment, student specific data is excluded from computation of the overall level of effectiveness, if the data is associated with students who were marked as statistical outliers in optional step S7.

Based on formulas (1), (2), (3), and (4), the total amount of time savings is computed based on all the student specific rating values recorded in step S3 for the instance of knowledge transfer, the amount of estimated maximum time savings assigned to the instance of knowledge transfer, all the students' competence levels stored in step S2, and all the student specific consulting quality levels stored in step S2. For example, the total amount of time savings is computed as a total value from all the student specific weighted amount of time savings T_{w2} computed and stored in step S10.

For statistical purposes, the scoring module 13 also computes total values of the student specific amounts of expected time savings Tₑₓₚ computed in step S5 and of the student specific weighted amounts of time savings T_{w1} computed in step S9. Moreover, the scoring module 13 computes average values of the rating values entered in step S3 for each of the quality indicators associated with the instance of knowledge transfer.

Furthermore, from student specific cost data stored in the database 10, the scoring module 13 also computes student specific cost savings and total cost savings expected from the instance of knowledge transfer. For example, the student specific cost data is recorded as hourly rate. The student specific cost savings are computed based on the student specific weighted amount of time savings T_{w2} computed and stored in step S10. The total cost savings are computed based on the total amount of time savings. The cost savings can be computed as daily, weekly, monthly, or yearly savings.

It must be pointed out that different sequences of steps S1 to S12 are possible without deviating from the scope of the invention. For example, one skilled in the art will understand, that steps S4 to S10 can be executed after step S11, i.e. after student specific data and rating values have been entered in steps S1 to S3 for all students to be considered in the evaluation of the instance of knowledge transfer. If there is no interest in student specific results, steps S4 to S10 can be omitted. One skilled in the art will also understand that step S12 can be executed before step S11, i.e. the overall level of effectiveness and the total time savings of the instance of knowledge transfer is computed in step S12 whenever the data and rating values of another student have been entered in steps S1 to S3.

1. A computer-based data processing system for assessing a level of effectiveness of knowledge transfer, the knowledge transfer being directed to more than one defined area of expertise, the system comprising
means for storing sets of quality indicators, each set of quality indicators being assigned to one of the defined areas of expertise,
a configuration module for specifying for an instance of knowledge transfer selected areas of expertise from the defined areas of expertise,
a rating module for receiving and storing rating values, each of the rating values being assigned to one of the quality indicators of a set assigned to one of the selected areas of expertise, and
a scoring module for computing from the rating values assigned to the quality indicators of the sets assigned to the selected areas of expertise the level of effectiveness of the instance of knowledge transfer directed to the selected areas of expertise.

2. The data processing system according to claim 1, further comprising means for receiving and storing amounts of estimated maximum time savings, each amount of estimated maximum time savings being assigned to one of the defined areas of expertise, and wherein the scoring module is designed to compute from the level of effectiveness and from the amounts of estimated maximum time savings an amount of expected time savings for the selected areas of expertise.

3. The data processing system according to claim 2, further comprising means for receiving and storing amounts of student specific, subjective time savings, wherein the rating module is designed to receive and store student specific rating values, wherein the scoring module is designed to compute student specific amounts of expected time savings, and wherein the scoring module is designed to compute student specific amounts of time savings from the student specific amounts of expected time savings and from the student specific amounts of subjective time savings.

4. The data processing system according to claim 3, wherein the scoring module is designed to compute the level of effectiveness of the knowledge transfer from student specific rating values of a plurality of students, and wherein the scoring module is designed to exclude student specific rating values from students with a student specific amount of expected time savings deviating by more than a defined value from the student specific amount of subjective time savings.

5. The data processing system according to claim 2, wherein the system further includes means for receiving and storing student specific competence levels indicating a student's level of competence prior to the knowledge transfer, and wherein the scoring module is designed to compute student specific amounts of expected time savings, the student specific amounts of expected time savings being weighted dependent on a student's specific competence level.

6. The data processing system according to claim 2, wherein the system further includes means for receiving and storing student specific consulting quality levels indicating a student's assessment of quality of the knowledge transfer, and wherein the scoring module is designed to compute student specific amounts of expected time savings, the student specific amounts of expected time savings being weighted dependent on a student's specific consulting quality level.

7. The data processing system according to claim 1, further comprising means for receiving and storing amounts of estimated maximum time savings, each amount of estimated maximum time savings being assigned to one of the defined areas of expertise, means for receiving and storing amounts of student specific, subjective time savings, means for receiving and storing student specific competence levels indicating a student's level of competence prior to the knowledge transfer, means for receiving and storing student specific consulting quality levels indicating a student's assessment of quality of the knowledge transfer, wherein the rating module is designed to receive and store student specific rating values, and wherein the scoring module is designed to compute an amount of expected time savings for the selected areas of expertise, the amount of expected time savings being computed from student specific amounts of expected time savings, the student specific amounts of expected time savings being computed from the amounts of estimated maximum time savings, from the student specific rating values, and from the amounts of student specific, subjective time savings, and the student specific amounts of expected time savings being weighted dependent on a student's specific competence level and on a student's specific consulting quality level.

8. The data processing system according to claim 1, wherein the system further includes means for assigning weighting factors to the quality indicators, and wherein the scoring module is designed to compute the level of effectiveness according to the weighting factors.

9. The data processing system according to claim 1, wherein the system further includes means for assigning weighting factors to the selected areas of expertise, and wherein the scoring module is designed to compute the level of effectiveness according to the weighting factors.

10. The data processing system according to claim 1, wherein the selected areas of expertise include management of electronic information, management of physical information, and planning and coordinating based on electronic and physical information, and wherein the instance of knowledge transfer relates information management.

11. The data processing system according to claim 1, further comprising a control module for controlling a user interface such that a user is prompted to enter rating values for all the quality indicators included in the sets of quality indicators assigned to the selected areas of expertise.

12. A computer implemented method for assessing a level of effectiveness of knowledge transfer, the knowledge transfer being directed to more than one defined area of expertise, the method comprising
storing sets of quality indicators in a database of a computer-based data processing system, each set of quality indicators being assigned to one of the defined areas of expertise,
specifying for an instance of knowledge transfer selected areas of expertise from the defined areas of expertise,
assigning in the database the selected areas of expertise to the instance of knowledge transfer,
receiving in the data processing system rating values for the quality indicators of the sets assigned to the selected areas of expertise,
storing the rating values in the database, each of the rating values being assigned to one of the quality indicators of the sets assigned to the selected areas of expertise, and
computing from the rating values assigned to the quality indicators of the sets assigned to the selected areas of expertise the level of effectiveness of the instance of knowledge transfer directed to the selected areas of expertise.

13. Computer program product comprising computer program code means for controlling one or more processors of a computer in a data processing system, such
that the computer stores sets of quality indicators in a database of the data processing system, each set of quality indicators being assigned to one of a plurality of defined areas of expertise,
that the computer receives specifications for selecting for an instance of knowledge transfer selected areas of expertise from the defined areas of expertise,
that the computer assigns the selected areas of expertise to the instance of knowledge transfer,
that the computer receives rating values for the quality indicators of the sets assigned to the selected areas of expertise,
that the computer stores the rating values in the database, each of the rating values being assigned to one of the quality indicators of the sets assigned to the selected areas of expertise, and
that the computer computes from the rating values assigned to the quality indicators of the sets assigned to the selected areas of expertise a level of effectiveness of the instance of knowledge transfer directed to the selected areas of expertise.
